(19) United States
(12) Patent Application Publication
(10) Pub. No.: US 2008/0310888 A1
(43) Pub. Date: Dec. 18, 2008

(54) DEVELOPING UNIT AND IMAGE FORMING APPARATUS EMPLOYING THE SAME

(75) Inventor: Ki-jae DO, Suwon-si (KR)

Correspondence Address: STANZIONE & KIM, LLP, 919 18TH STREET, N.W., SUITE 440, WASHINGTON, DC, 20006, US

(73) Assignee: Samsung Electronics Co., Ltd., Suwon-si (KR)

(21) Appl. No.: 12/028,057

(22) Filed: Feb. 8, 2008

(30) Foreign Application Priority Data
Jun. 14, 2007 (KR) 2007-58348

(51) Int. Cl. G03G 15/08

(52) U.S. Cl. 399/284

(57) ABSTRACT

A developing unit is provided that includes a housing to store toner, a developing member disposed proximate to the housing to rotate around a first rotation axis, and opposite to the photosensitive medium, and a cylindrical regulating member to rotate about a second rotation axis and to regulate the toner supplied to the developing member to form a uniform toner layer on the developing member, wherein the first and second rotation axes form a predetermined offset angle θ with each other. The angle satisfies the following formula: 0.25°≦θ≦0.71°. The regulating member is arranged so that a center of each end portion of the regulating member which contacts the developing member is offset with respect to the first rotation axis of the developing member by an eccentric distance M, which satisfies the following formula: 0.5 mm≦M≦1.3 mm.

### CROSS-REFERENCE TO RELATED APPLICATIONS

This application claims priority under 35 U.S.C. §119(a) from Korean Patent Application No. 10-2007-0058348, filed on Jun. 14, 2007 in the Korean Intellectual Property Office, the disclosure of which is incorporated herein by reference in its entirety.

### BACKGROUND OF THE INVENTION

1. Field of the Invention

The present general inventive concept relates to a developing unit and an image forming apparatus employing the same, and more particularly, to a developing unit which has an improved regulating member to regulate a toner layer formed on a developing roller and an image forming apparatus employing the same.

2. Description of the Related Art

In general, an electrophotographic type of image forming apparatus scans light on a photosensitive medium charged at a predetermined electric potential to form an electrostatic latent image, develops the latent image with toner of predetermined colors, and then, transfers, fuses and prints an image on a printing medium.

Such an image forming apparatus is classified into a wet type and a dry type according to a state of developer. The dry type of image forming apparatus is classified into a bi-component type and a mono-component type according to whether the apparatus uses a carrier. The bi-component type uses developer made of toner and a powdered carrier, and the mono-component type uses developer made of toner only.

The mono-component type of image forming apparatus includes a photosensitive medium on which an electrostatic latent image is formed by a charge and an exposure process, and a developing unit which supplies toner to the photosensitive medium to form an image.

Such a conventional developing unit is disclosed in a Japanese Patent Laid-open Publication No. Hei 7-64394. This developing unit includes a developing roller having elasticity which is disposed opposite to a photosensitive drum and supplies developer to an electrostatic latent image, and a toner layer forming roller (hereinafter, to be referred to as a regulating roller) which contacts a surface of the developing roller and forms a thin developer layer on the surface of the developing roller.

In order to form the developer layer on the surface of the developing roller, the regulating roller should be pressed toward the developing roller, for example, by pressing opposite end portions of the regulating roller. However, a pressure distribution varies along an axial direction of the regulating roller, and thus, it is difficult to perform a uniform regulation at a central portion of the regulating roller.

To solve the problem, according to the above Japanese developing unit, opposite end portions of the regulating roller is crown-processed so that the opposite end portions of the regulation roller are smaller in diameter than the central portion thereof to make uniform a pressure distribution along an axial direction thereof.

A difference between diameters of the crown-processed opposite end portions and the central portion should be in the range of 100-200 μm per a diameter of 200 mm.

However, where the regulating roller is made of steel, the crown-processing is relatively difficult and requires a relatively high manufacturing cost. Further, the crown-processing may also require tubing a crown-processed rubber layer on the regulating roller resulting in the manufacturing cost becoming even higher.

### SUMMARY OF THE INVENTION

The present general inventive concept provides a developing unit to provide a uniform pressure distribution without crown-processing a developer layer regulating member and an image forming apparatus employing the same.

Additional aspects and utilities of the present general inventive concept will be set forth in part in the description which follows and, in part, will be obvious from the description, or may be learned by practice of the present general inventive concept.

The foregoing and/or other aspects and utilities of the present general inventive concept can be achieved by providing a developing unit to form a visible image comprising a housing to store toner, a developing member disposed proximate to the housing to rotate about a first rotation axis, and opposite to the photosensitive medium, and a cylindrical regulating member to rotate about a second rotation axis and to regulate the toner supplied to the developing member to form a uniform toner layer on the developing member, wherein the first and second rotation axes form a predetermined offset angle θ with each other.

The predetermined offset angle may satisfy the following formula: 0.25°≦θ≦0.71°.

The regulating member may be disposed in the housing to contact the developing member.

The regulating member may be arranged so that a center of each end portion of the regulating member which contacts the developing member is offset with respect to the first rotation axis of the developing member by an eccentric distance M, which satisfies the following formula: 0.5 mm≦M≦1.3 mm.

The foregoing and/or other aspects and utilities of the general inventive concept may also be achieved by providing a developing unit usable with an image forming apparatus comprising a developing roller to rotate about a rotation axis and a regulating member to provide uniform pressure to the developing roller along an axial direction of the regulating member and toner supplied to the developing roller to form a toner layer on the developing roller, a first longitudinal line extending through a center of the regulating member and a second longitudinal line extending through a center of the developing member not in parallel with respect to the first longitudinal line.

The first and second longitudinal lines form a predetermined offset angle with respect to each other so that the predetermined offset angle may satisfy the following formula: 0.25°≦θ≦0.71°.

The regulating blade may contact the developing roller to regulate the toner supplied to the developing roller.

The regulating blade may be arranged so that a center of each end portion of the regulating blade which contacts the developing roller is offset with respect to the rotation axis of the developing roller by an eccentric distance M, which satisfies the following formula: 0.5 mm≦M≦1.3 mm.

The developing unit may further comprise a supplying roller to rotate in contact with the developing roller and to adhere the toner to the developing roller.

The foregoing and/or other aspects and utilities of the general inventive concept may also be achieved by providing an image forming apparatus comprising a photosensitive medium on which a latent image is formed by a charge and an exposure process, a developing unit to supply toner to the photosensitive medium to form a visible image corresponding to the latent image, the developing unit comprises a housing to store the toner, a developing member disposed proximate to the housing to rotate about a first rotation axis, and opposite to the photosensitive medium and a cylindrical regulating member to rotate about a second rotation axis, and to regulate the toner supplied to the developing member to form a uniform toner layer on the developing member, wherein the first and second rotation axes form a predetermined offset angle θ with respect to each other, a transfer unit to transfer the visible image formed by the developing unit to a printing medium and a fusing unit to fuse the visible image transferred to the printing medium.

The foregoing and/or other aspects and utilities of the general inventive concept may also be achieved by providing an image forming apparatus comprising a frame and a developing unit detachable coupled to the frame, the developing unit comprising a developing roller to rotate about a rotation axis, and a regulating member to provide uniform pressure to the developing roller along an axial direction of the regulating member and toner supplied to the developing roller to form a toner layer on the developing roller, a first longitudinal line extending through a center of the regulating member and a second longitudinal line extending through a center of the developing member not in parallel with respect to the first longitudinal line.

The foregoing and/or other aspects and utilities of the present general inventive concept can also be an image developing method comprising regulating a longitudinal surface of a developing member configured to supply developing material with a regulating surface that is offset with respect to a rotation axis of the developing member.

### BRIEF DESCRIPTION OF THE DRAWINGS

These and/or other aspects and utilities of the present general inventive concept will become apparent and more readily appreciated from the following description of the exemplary embodiments, taken in conjunction with the accompanying drawings, in which:

FIG. 1 is a schematic section view illustrating a developing unit according to an exemplary embodiment of the present general inventive concept;

FIGS. 2 and 3 are schematic views illustrating an arrangement of a developing roller and a regulating roller of the developing unit according to the exemplary embodiment of FIG. 1;

FIG. 4 illustrates a crown-processed regulating roller of a conventional developing unit;

FIG. 5 is a graph illustrating a relation between a crown depth D in the conventional developing unit and an eccentric distance M in the developing unit according to the exemplary embodiment of FIG. 1;

FIG. 6 is a schematic section view illustrating a developing unit according to another exemplary embodiment of the present general inventive concept;

FIGS. 7 and 8 are schematic views illustrating an arrangement of a developing roller and a regulating blade of the developing unit according to the exemplary embodiment as illustrated in FIGS. 6;

FIG. 9 is a schematic view illustrating an image forming apparatus employing the developing unit according to the exemplary embodiments of the present general inventive concept; and

FIG. 10 illustrates a flowchart illustrating an image developing method according to another exemplary embodiment of the present general inventive concept.

### DETAILED DESCRIPTION OF THE PREFERRED EMBODIMENTS

Reference will now be made in detail to embodiments of the present general inventive concept, examples of which are illustrated in the accompanying drawings, wherein like reference numerals refer to like elements throughout. The embodiments are described below so as to explain the present general inventive concept by referring to the figures.

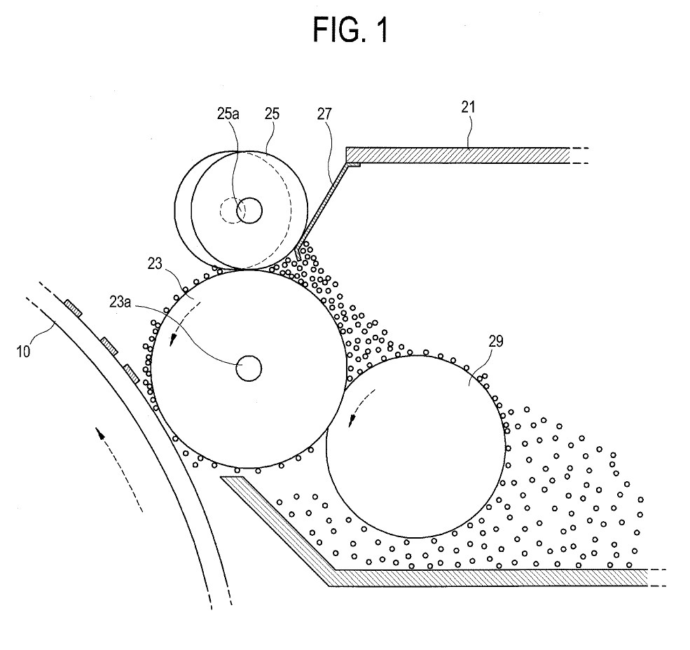

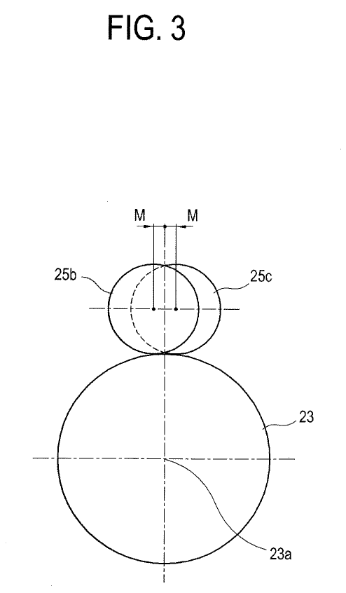

Referring to FIGS. 1 to 3, a developing unit according to an exemplary embodiment of the present general inventive concept includes a housing 21 to store toner T, and a developing roller 23 and a regulating roller 25 which are disposed proximate to the housing 21.

The developing roller 23 rotates about a first rotation shaft 23a in a state that a portion thereof is exposed outside of the housing 21. The developing roller 23 supplies the toner T to a photosensitive medium 10 by a potential difference to develop a visible image. A latent image forms on the photosensitive medium 10 by a charge and an exposure process, to which the developing roller 23 develops the visible image.

The regulating roller 25 regulates the toner T supplied to the developing roller 23 to form a uniform toner layer on the developing roller 23. The regulating roller 25 rotates about a second rotation shaft 25a and has a cylindrical shape to have substantially a same diameter along an axial direction of the second rotation shaft 25a. Accordingly, a manufacturing process of the cylindrical regulating roller 25 becomes relatively simple and the manufacturing cost becomes relatively low, compared with the conventional crown-processed regulating roller.

The regulating roller 25 may contact the developing roller 23 as illustrated in FIG. 1. Alternatively, with respect to the bi-component type, the regulating roller 25 may not contact the developing roller 23 to regulate the toner layer.

Hereinafter, where the regulating roller 25 contacts the developing roller 23 will be described by way of example.

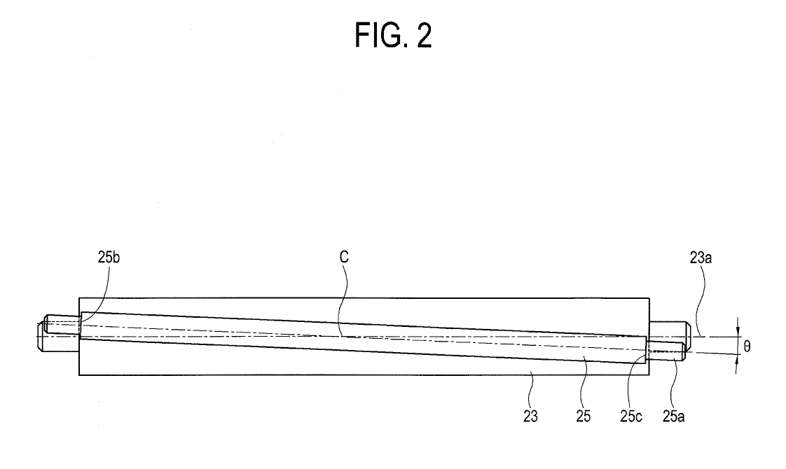

In the developing unit according to the present embodiment, to make uniform a contact pressure between the developing roller 23 and the regulating roller 25 over an entire contact area, the second rotation shaft 25a is misaligned with respect to the first rotation shaft 23a by an angle θ. More particularly, as illustrated in FIG. 2, the first rotation shaft 23a and the second rotation shaft 25a are not parallel to each other and the developing roller 23 and the regulating roller 25 cross each other at a central portion C such as a central point thereof. That is, a longitudinal axis extending through a center of the first rotation shaft 23a and a longitudinal axis extending through the second rotation shaft 25a form the angle θ.

Accordingly, when the opposite end portions 25b and 25c are pressed, the developing roller 23 and the regulating roller 25 firstly contact each other at the central portion C, and then, gradually contact each other toward the opposite end portions while the regulating roller 25 is bending, thereby providing a uniform contact pressure over the entire contact area.

To obtain the uniform contact pressure over the entire contact area, the angle θ may satisfy the following formula 1:

0.25°≦θ≦0.71°

Here, upper and lower limits of the angle θ are set in consideration of diameters, materials and lengths of the developing roller 23 and the regulating roller 25 and on the basis of results of experimental examples 1 to 3 (to be described later).

If the angle θ is beyond the lower limit in the formula 1, when the opposite end portions of the regulating roller 25 are pressed, the pressure applied at the opposite end portions of the regulating roller 25 is larger than that at the central portion thereof, and thus, the pressure distribution becomes non-uniform.

Alternatively, if the angle θ is beyond the upper limit in the formula 1, the opposite end portions of the regulating roller 25 do not contact the developing roller 23 or contact the developing roller 23 at a pressure less than that at the central portion thereof, thereby causing non-uniform forming of the toner layer on the developing roller 23. Accordingly, if the pressure applied to the opposite end portions of the regulating roller 25 is increased to obtain a uniform contact pressure, the regulating roller 25 may be deformed.

Alternatively, in the developing unit according to the present embodiment, an eccentric distance M may satisfy the following formula 2:

0.5 mm≦M≦1.3 mm

Here, the eccentric distance M is defined as half of a distance between centers of the opposite end portions of the regulating roller 25 which are in contact with the developing roller 23. That is, the eccentric distance M is an offset distance between the center of the respective opposing end portion 25b and 25c and the center portion C (where the longitudinal axes of the first and second rotation shafts 23a and 25a intersect) projected to a vertical plane including the respective opposing end portion 25b and 25c. Accordingly, a sum of the eccentric distances between the opposite end portions of the regulating roller 25 is 2×M.

The formula 1 may be replaced with the formula 2 considering a length of the regulating roller 25. More particularly, where the length (L) of the regulating roller 25 is set according to a width (210 mm) of a printing paper of A4, the formula 2 may be obtained in consideration of the following formula 3:

θ=tan⁻¹(2 M/L)

Significances of lower and upper limits of the formula 2 are substantially the same as the lower and upper limits of the formula 1, and thus, a detailed description thereof will be omitted.

The developing unit according to the present embodiment may further include a blade 27 and a supplying roller 29.

The blade 27 is disposed proximate to the housing 21, and contacts the regulating roller 25 to prevent leakage of the toner T contained in the housing 21 and clean the toner T adhered to the regulating roller 25.

The supplying roller 29 is disposed inside the housing 21, and rotates in contact with the developing roller 23 to supply the toner T to the developing roller 23. The supplying roller 29 may include a sponge material or the like on an outer circumferential surface thereof to facilitate adhesion of the toner T to the circumferential surface and provide a relatively wide contact nip against the developing roller 23.

The supplying roller 29 supplies the toner T to the developing roller 23, and maintains supply of the toner T in a stable manner. To this end, a bias power with a predetermined electric potential is applied to the supplying roller 29 from a power supply (not illustrated). The toner T is charged at a predetermined electric potential by the bias power. Further, the supplying roller 29 cleans the toner T remaining on the developing roller 23 after development of the visual image.

Hereinafter, the experimental examples 1 to 3 will be described for the developing unit according to the present embodiment.

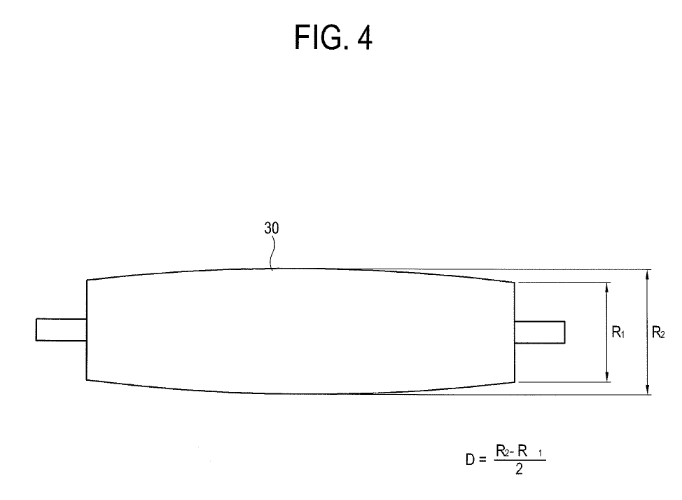

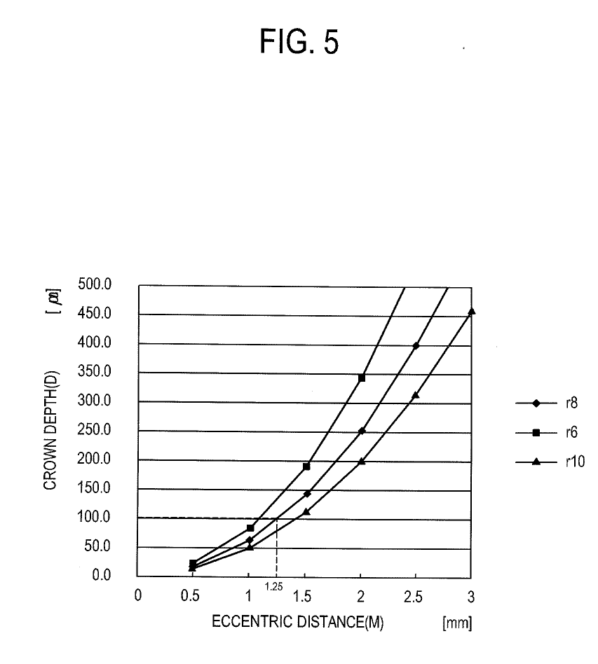

For experimental purposes, a crown-processed regulating roller 30 as illustrated in FIG. 4 has been provided. The relation between a crown depth D of the regulating roller 30 and an eccentric distance M of the developing unit is illustrated in FIG. 5.

In the regulating roller 30 as illustrated in FIG. 4, the crown depth D is defined as (R2−R1)/2, where R1 is a diameter of the opposite end portions of the regulating roller 30 and R2 is a diameter of the central portion thereof.

The experiments are made for the mono-component type of developing unit, and experimental conditions are as follows.

### EXPERIMENTAL EXAMPLE 1

A developing roller used for this experiment includes a shaft made of stainless steel and having a diameter of 14.0 mm and a rubber layer thereon having a thickness of 1.0 mm, and thus, has a total diameter of 16.0 mm. A surface roughness of the developing roller is 6-14 μm. A regulating roller used for this experiment is made of stainless steel and has a diameter of 10.0 mm and a surface roughness (Rz) of 1-2 μm. The Rz of the developing roller has been determined considering that the thickness of the toner layer becomes too thin when the Rz of the developing roller is too small and the thickness of the toner layer becomes non-uniform when the Rz of the developing roller is too large.

### EXPERIMENTAL EXAMPLE 2

The specification of a developing roller used for this experiment is the same as that of the developing roller in the experimental example 1. A regulating roller includes a shaft made of stainless steel and having a diameter of 10.0 mm and a tubing layer thereon having a thickness of 1.0 mm. This regulating roller has a substantially cylindrical shape, which is not crown-processed, and tubing-processed with a nylon material on an outer circumference thereof. A surface roughness (Rz) of the regulating roller is about 1.5 μm.

### EXPERIMENTAL EXAMPLE 3

A developing roller used for this experiment includes a shaft made of stainless steel and having a diameter of 14.0 mm and a rubber layer having a thickness of 3.0 mm. The rubber layer has a hardness of 50 (Asker-A) and a surface roughness (Rz) of 10 μm. The specification of a regulating roller used for this experiment is the same as that of the experimental example 1 or 2.

The results of the above experiments are illustrated as r8 in FIG. 5. For example, an eccentric distance of 1.25 mm corresponds to a crown depth of 100 μm, and the thickness of the toner layer and the charge distribution on the developing roller become uniform.

Particularly, with respect to the experimental example 3 in which the developing roller has the rubber layer thicker than those of the experimental examples 1 and 2, even when the eccentric distance is smaller than 1.25 mm, for example, approximately 1.0 mm, the thickness of the toner layer and the charge distribution on the developing roller become uniform.

For reference, r6 and r10 in FIG. 5 each represent experimental results where the diameters of the developing roller are 12.0 mm and 20.0 mm, respectively. Accordingly, the relations between the eccentric distances M and the crown depths D are varied within an allowable range compared with r8. Accordingly, if the eccentric distance M is set on a basis of the experiments, even if the regulating roller has a cylindrical shape without crown-processing, the thickness of the toner layer and the charge distribution on the developing roller can become uniform, similar to where the regulating roller is crown-processed.

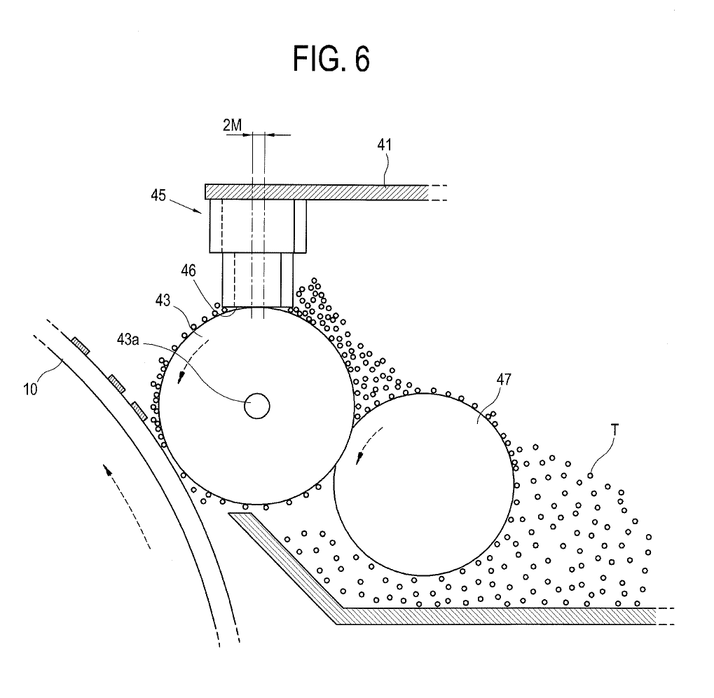

Referring to FIGS. 6 to 8, a developing unit according to another embodiment of the present general inventive concept includes a housing 41 in which toner T is contained, and a developing roller 43 and a regulating blade 45 which are installed to the housing 41.

The developing roller 43 rotates by a rotation shaft 43a with a portion thereof being exposed outside of the housing 41, and supplies the toner T to a photosensitive medium 10 to develop a visible image.

The regulating blade 45 regulates the toner T which is supplied to the developing roller 43 and makes uniform a toner layer formed on the developing roller.

The regulating blade 45 may be provided to contact the developing roller 43, as illustrated in FIG. 6. Alternatively, with respect to the bi-component type, the regulating blade 45 may not contact the developing roller 43 to regulate the toner layer. Hereinafter, where the regulating blade 45 contacts the developing roller 43 will be described by way of example.

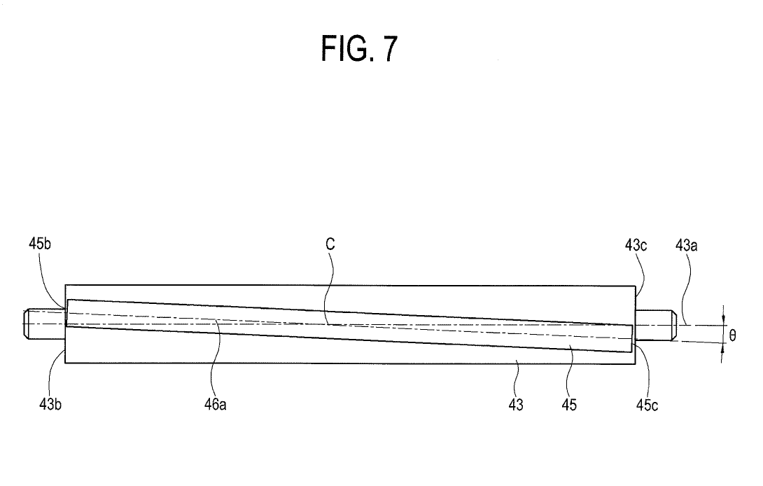

As illustrated in FIG. 7, the regulating blade 45 is arranged so that a central line 46a of the regulating blade 45 forms a predetermined offset angle θ with a central line of the rotation shaft 43a of the developing roller 43. Here, the central line 46a connects a first center of one end portion 45b of the opposing end portions of the regulating blade 45, which contacts a first end portion 43b of the developing roller 43, and a second center of another end portion 45c of the opposing end portions of the regulating blade 45 which contacts a second end portion 43c of the developing roller 43.

As illustrated in FIG. 7, the central line 46a of the regulating blade 45 and the central line of the rotation shaft 43a cross each other at a central portion C. Accordingly, if the opposite end portions of the regulating blade 45 is pressed, the regulating blade 45 firstly contacts the developing roller 43 at the central portion C, and then, gradually contacts the developing roller 43 toward the opposite end portions thereof, thereby providing a uniform contact pressure distribution over the entire contact area.

To make the contact pressure distribution uniform, the angle θ may satisfy the above-described formula 1, and an eccentric distance M may satisfy the above-described formula 2.

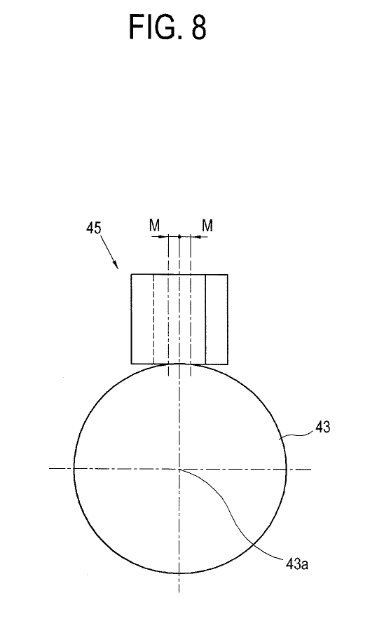

Here, the eccentric distance M is defined as half of an offset distance between the first and second centers of the opposing end portions 45b and 45c of the regulating blade 45 or an eccentric distance between the first or second center of the respective opposing end portions 45b and 45c of the regulating blade 45 and the central line of the rotation shaft 43a, as illustrated in FIG. 8. That is, the eccentric distance M is an offset distance between the center of the respective opposing end portion 45b and 45c of the regulating blade 45 and the center portion C (where the central line 46a of the regulating blade 45 and the central line of the rotation axis 43a of the developing roller 43 intersect) projected to a vertical plane including the respective opposing end portion 45b and 45c. Accordingly, a total eccentric distance between the opposite end portions 45b and 45c of the regulating blade 45 is 2×M.

The developing unit according to the present embodiment may further include a supplying roller 47, as illustrated in FIG. 6. The supplying roller 47 is disposed inside of the housing 41 and rotates in contact with the developing roller 43 to supply the toner T to the developing roller 43. The supplying roller 47 may include a sponge member or the like on an outer circumference thereof to facilitate adhesion of the toner T and to provide a relatively wide contact nip against the developing roller 43. The configuration of the supplying roller 47 is substantially the same as the supplying roller 27 (in FIG. 1) according to the first embodiment of the present general inventive concept as illustrated in FIG. 1, and thus, the detailed description thereof will be omitted.

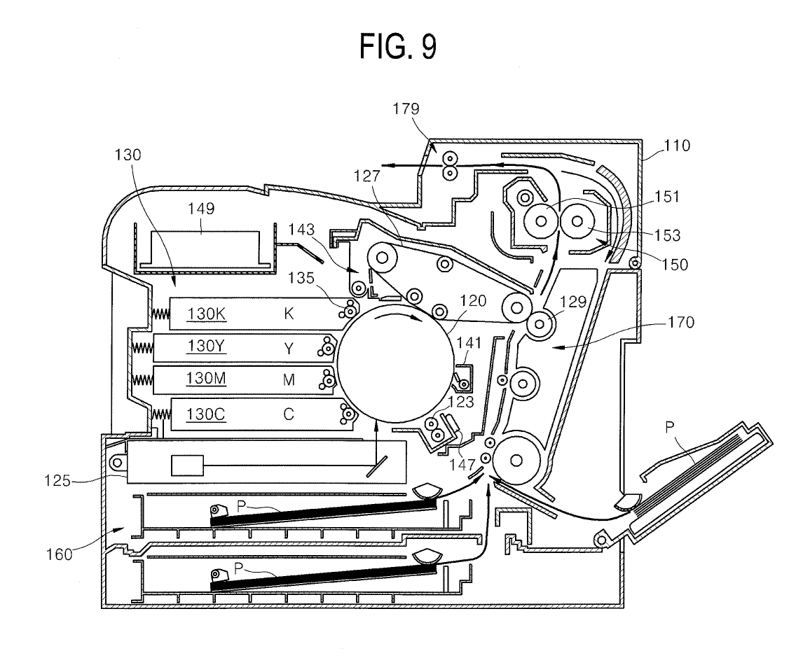

Referring to FIG. 9, an electrophotographic image forming apparatus employing the above-described developing units according to embodiments of the present general inventive concept includes a cabinet 110. A photosensitive medium 120, a light scanning unit 125, a transfer unit 127, a developing unit 130 and a fusing unit 150 are disposed inside the cabinet 110.

The photosensitive medium 120 is charged by a charging roller 123 and exposed by a light beam scanned from the light scanning unit 125 to form an electrostatic latent image. The photosensitive medium 120 is provided as a photosensitive drum which includes a cylindrical drum made of metal and a light conductive layer formed on the cylindrical drum.

The charging roller 123 is a type of charger to charge the photosensitive drum 120 at a uniform electric potential. That is, the charging roller 123 rotates in contact or non-contact with the photosensitive drum 120 and supplies electric charges to the light conductive layer of the photosensitive drum 120 so that the light conductive layer has a uniform electric potential. Here, the charger may be provided as a known corona charger in place of the charging roller 123.

The light scanning unit 125 scans a light beam onto the photosensitive drum 120 charged at a uniform electric potential to form an electrostatic latent image corresponding to image information.

The developing unit 130 includes a first to a fourth developing units 130C, 130M, 130Y and 130K. The developing units 130C, 130M, 130Y and 130K each contain toners having colors of cyan (C), magenta (M), yellow (Y) and black (K).

Each of the developing units 130C, 130M, 130Y and 130K includes a developing roller 135 which supplies the toner to the photosensitive drum 120 to form a toner image with respect to the electrostatic latent image formed on the photosensitive drum 120.

Here, between the developing roller 135 and the photosensitive drum 120 exists a developing gap of several tens to several hundreds of microns, and accordingly, the developing process is performed in a non-contact method.

In the developing process, when the photosensitive drum 120 rotates 1 time, only the developing roller 135 of one of the developing units 130C, 130M, 130Y and 130K works for the development.

The configuration of each of the developing units 130C, 130M, 130Y and 130K is the same as the developing units described above referring to FIGS. 1 to 8.

The transfer unit 127 may be provided as a transfer belt. The transfer belt 127 transfers an image developed on the photosensitive drum 120 and transfers the image to a printing medium P. Here, the toner images of the respective colors sequentially formed on the photosensitive drum 120 are sequentially and superposingly transferred to the transfer belt 127 to form a color image.

The image forming apparatus may further include first and second cleaning units 141 and 143, an erasing lamp 147, a power supply 149 and a printing medium supplying unit 160.

The first cleaning unit 141 cleans the toner remaining on the photosensitive drum 120 after the toner image is transferred to the transfer belt 127. The second cleaning unit 143 cleans the toner remaining on the transfer belt 127 after the image on the transfer belt 127 is transferred to the printing medium P.

The erasing lamp 147 eliminates electric charges remaining on the photosensitive drum 120 before charge. More particularly, the erasing lamp 147 emits a predetermined amount of light onto the photosensitive drum 120 to eliminate the remaining electric charges.

The power supply 149 supplies a developing bias power, a development preventing bias power, first and second transfer bias powers, and a charge bias power.

The developing bias power is supplied to develop the toner from each of the first to fourth developing units 130C, 130M, 130Y and 130K to the photosensitive drum 120.

The development preventing bias power is supplied to prevent the toner from being transferred to the photosensitive drum 120 from the developing units other than the developing unit having a color under development.

The first transfer bias power is supplied to transfer the toner image to the transfer belt 127 from the photosensitive drum 120.

The second transfer bias power is supplied to transfer the toner image to the printing medium P from the transfer belt 127.

The charge bias power is applied to the charging roller 123.

The fusing unit 150, which fuses the toner image transferred to the printing medium P, includes a pair of fusing rollers 151 and 153 which rotate in engagement with each other under a predetermined pressure. To at least one of the pair of fusing rollers 151 and 153 is provided a heating unit (not illustrated). Accordingly, when the printing medium P transferred the toner image passes through the fusing unit 150, the toner image is fused onto the printing medium P by heat and pressure, thereby completing image printing.

The printing medium supplying unit 160 contains therein printing media P. A printing medium P is supplied from the printing medium supplying unit 160 and moves to a path between the transfer belt 127 and the pressing roller 129 via a printing medium feeding unit 170. The printing medium P on which the image is printed is discharged outside of the cabinet 110 through a discharging roller 179.

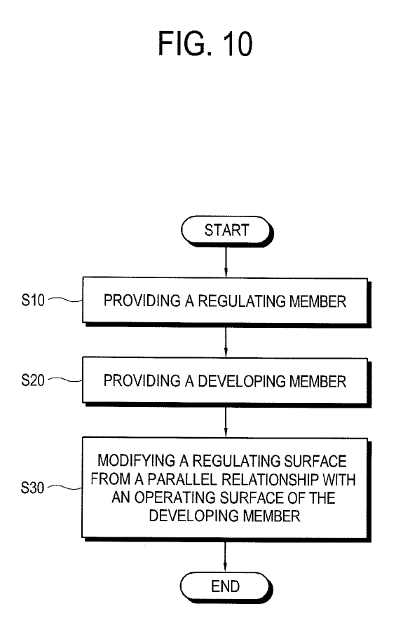

FIG. 10 is a diagram that illustrates an image developing method in accordance with another exemplary embodiment of the present general inventive concept. The method embodiment of FIG. 10 will be described using the embodiment of FIG. 1, however, the method embodiment of FIG. 10 or the present general inventive concept is not intended to be limited thereby.

First, a developing member such as developing roller 23 of a developing unit is provided to supply the toner T to a photosensitive medium such as photosensitive medium 10 at operation S10. As illustrated in FIG. 1, the developing roller 23 rotates by the first rotation shaft 23a.

Second, a regulating member such as the regulating roller 25 of a developing unit is provided to regulate the developing member (e.g., a thickness of a toner layer) at operation S20. The regulating roller 25 regulates the toner T supplied to the developing roller 23 to form a uniform toner layer on the developing roller 23. The regulating roller 25 rotates by a second rotation shaft 25a and has a cylindrical shape to have the substantially same diameter along an axial direction of the second rotation shaft 25a.

Then, the regulating member is arranged so that a regulating surface (e.g., a flat planar surface, contacting portion of a cylindrical surface or the like) is modified from a parallel relationship to an operating surface of the developing member at operation S30. The operating surface of the developing member is along an longitudinal direction of the developing member (e.g., parallel to a width dimension of the printing medium P). As illustrated in FIG. 1, the operating surface of developing roller 23 is parallel to the first rotation axis 23a.

In this exemplary manner, when force is applied to the regulating member (e.g., opposite end portions 25b and 25c are pressed), uniform or substantially uniform contact pressure over an engagement region between the regulating surface and the operating surface (e.g., between the developing roller 23 and the regulating roller 25) can be provided. For example, the developing roller 23 and the regulating roller 25 contact each other first at or along the central portion C, and then, gradually contact toward the opposite end portions to provide a uniform contact pressure over the whole engagement region (e.g., from end portions 25b to end portion 25c.

Further, at the operation S30, developing material (e.g., toner) on the developing roller 23 becomes uniform or substantially uniform. As illustrated in exemplary embodiments, methods of arranging the regulating member from a parallel relationship can include setting the angle θ to satisfy formula 1, or setting an eccentric distance M to satisfy the formula 2. In such embodiments, the regulating surface is moved relative to the developing member, however, the present general inventive concept is not intended to be so limited as other exemplary arrangements may appropriately modify a parallel relationship between the developing member (e.g., developing roller 23) and the regulating member (e.g., regulating roller 25) to provide a substantially uniform toner layer (e.g., with/without crown-processing the regulating roller 30). For example, the position of the developing member may be modified relative to the regulating member (or both changed) to alter a parallel relationship.

As described above, apparatuses and methods of a developing unit according to the various exemplary embodiments of the present general inventive concept and an image forming apparatus employing the same can provide a uniform pressure distribution between a developing roller and a regulating member (that is, a regulating roller or a regulating blade) without crown-processing of the regulating member. Further, apparatuses and/or methods of a developing unit according to exemplary embodiments can provide a uniform layer on a developing member.

Accordingly, a regulating member can be manufactured in a simple manner compared with the conventional crown-processed regulating member, and thus, the manufacturing costs of a developing unit and an image forming apparatus employing the same can be decreased.

Although various exemplary embodiments of the present general inventive concept have been illustrated and described, it will be appreciated by those skilled in the art that changes may be made in these embodiments without departing from the principles and spirit of the general inventive concept, the scope of which is defined in the appended claims and their equivalents. As used in this disclosure, the term “preferably” is non-exclusive and means “preferably, but not limited to.” Terms in the claims should be given their broadest interpretation consistent with the general inventive concept as set forth in this description. For example, the terms “coupled” and “connect” (and derivations thereof) are used to connote both direct and indirect connections/couplings. As another example, “having” and “including”, derivatives thereof and similar transitional terms or phrases are used synonymously with “comprising” (i.e., all are considered “open ended” terms)—only the phrases “consisting of” and “consisting essentially of” should be considered as “close ended”. Claims are not intended to be interpreted under 112 sixth paragraph unless the phrase “means for” and an associated function appear in a claim and the claim fails to recite sufficient structure to perform such function.

What is claimed is:

1. A developing unit to form a visible image on a photosensitive medium, the developing unit comprising:
a housing to store toner;
a developing member disposed proximate to the housing to rotate about a first rotation axis, and opposite to the photosensitive medium; and
a cylindrical regulating member to rotate about a second rotation axis, and to regulate the toner supplied to the developing member to form a uniform toner layer on the developing member,
wherein the first and second rotation axes form a predetermined offset angle θ with respect to each other.

2. The developing unit according to claim 1, wherein the predetermined offset angle θ satisfies the following formula:
0.25°≦θ≦0.71°.

3. The developing unit according to claim 2, wherein the regulating member is disposed in the housing to contact the developing member.

4. The developing unit according to claim 3, wherein the regulating member is arranged so that a center of each end portion of the regulating member which contacts the developing member is offset with respect to the first rotation axis of the developing member by an eccentric distance M, which satisfies the following formula:
0.5 mm≦M≦1.3 mm.

5. The developing unit according to claim 4, further comprising:a supplying member to rotate in contact with the developing member and to adhere the toner to the developing member.

6. A developing unit usable with an image forming apparatus, comprising:
a developing roller to rotate about a rotation axis; and
a regulating member to provide uniform pressure to the developing roller along an axial direction of the regulating member and toner supplied to the developing roller to form a toner layer on the developing roller,
a first longitudinal line extending through a center of the regulating member and a second longitudinal line extending through a center of the developing member not in parallel with respect to the first longitudinal line.

7. The developing unit according to claim 6, wherein the first and second longitudinal lines form a predetermined offset angle θ with respect to each other so that the predetermined offset angle θ satisfies the following formula:
0.25°≦θ≦0.71°.

8. The developing unit according to claim 7, wherein the regulating blade contacts the developing roller and regulates the toner supplied to the developing roller.

9. The developing unit according to claim 8, wherein the regulating blade is arranged so that a center of each end portion of the regulating blade which contacts the developing roller is offset with respect to the rotation axis of the developing roller by an eccentric distance M, which satisfies the following formula:
0.5 mm≦M≦1.3 mm.

10. The developing unit according to claim 9, further comprising:
a supplying roller to rotate in contact with the developing roller and to adhere the toner to the developing roller.

11. An image forming apparatus, comprising:
a photosensitive medium on which a latent image is formed by a charge and an exposure process;
a developing unit to supply toner to the photosensitive medium to form a visible image corresponding to the latent image, the developing unit comprises:
a housing to store the toner;
a developing member disposed proximate to the housing to rotate about a first rotation axis, and opposite to the photosensitive medium; and
a cylindrical regulating member to rotate about a second rotation axis, and to regulate the toner supplied to the developing member to form a uniform toner layer on the developing member,
wherein the first and second rotation axes form a predetermined offset angle θ with respect to each other;
a transfer unit to transfer the visible image formed by the developing unit to a printing medium; and
a fusing unit to fuse the visible image transferred to the printing medium.

12. The image forming apparatus according to claim 11, wherein the predetermined offset angle θ satisfies the following formula:
0.25°≦θ≦0.71°.

13. The image forming apparatus according to claim 12, wherein the regulating roller is disposed in the housing to contact the developing roller.

14. The image forming apparatus according to claim 13, wherein the regulating roller is arranged so that a center of each end portion of the regulating roller which contacts the developing roller is offset with respect to the first rotation axis of the developing roller by an eccentric distance M, which satisfies the following formula:
0.5 mm≦M≦1.3 mm.

15. The image forming apparatus according to claim 14, wherein the developing unit further comprises:
a supplying roller to rotate in contact with the developing roller and to adhere the toner to the developing roller.

16. An image forming apparatus, comprising:
a frame; and
a developing unit detachable coupled to the frame, the developing unit comprising:
a developing roller to rotate about a rotation axis; and
a regulating member to provide uniform pressure to the developing roller along an axial direction of the regulating member and toner supplied to the developing roller to form a toner layer on the developing roller,
a first longitudinal line extending through a center of the regulating member and a second longitudinal line extending through a center of the developing member not in parallel with respect to the first longitudinal line.

17. The image forming apparatus according to claim 16, wherein the first and second longitudinal lines form a predetermined offset angle θ with respect to each other so that the predetermined offset angle θ satisfies the following formula:
0.25°≦θ≦0.71°.

18. The image forming apparatus according to claim 17, wherein the regulating blade contacts the developing roller and regulates the toner supplied to the developing roller.

19. The image forming apparatus according to claim 18, wherein the regulating blade is arranged so that a center of each end portion of the regulating blade which contacts the developing roller is offset with respect to the rotation axis of the developing roller by an eccentric distance M, which satisfies the following formula:
0.5 mm≦M≦1.3 mm.

20. The image forming apparatus according to claim 19, wherein the developing unit further comprises:
a supplying roller to rotate in contact with the developing roller and to adhere the toner to the developing roller.

21. An image developing method, comprising:
regulating a longitudinal surface of a developing member configured to supply developing material with a regulating surface that is offset with respect to a rotation axis of the developing member.

22. The image developing method of claim 21, wherein the regulating surface is rotated around a regulating rotation axis to regulate a regulating material layer on the developing member, the rotation axis of the developing member and the axis of the regulating surface being offset from each other.

23. The image developing method of claim 22, wherein the rotation axis of the developing member and the rotation axis of the regulating surface are offset by an angle θ, wherein 0.25°≦θ≦0.71°.

24. The image developing method of claim 21, wherein a center of opposing ends of the regulating surface are offset with respect to the longitudinal surface of the developing member by a predetermined distance M, where M is 0.5 mm≦M≦1.3 mm.
